(19) United States
(12) Patent Application Publication
(10) Pub. No.: US 2026/0171733 A1
(43) Pub. Date: Jun. 18, 2026

(54) CONNECTION APPARATUS FOR BUSWAY

(71) Applicant: Schneider Electric Industries SAS, Rueil-Malmaison (FR)

(72) Inventors: Tianjin XIAO, Guangdong (CN); Jianyuan HUANG, Guangdong (CN)

(21) Appl. No.: 19/393,745

(22) Filed: Nov. 19, 2025

(30) Foreign Application Priority Data
Dec. 12, 2024 (CN) 202423078614X

(51) Int. Cl. H01R 13/73; H01R 11/01; H01R 13/512; H01R 13/52; H01R 13/631; H01R 13/6581; H01R 13/70; H01R 13/713

(52) U.S. Cl. CPC H01R 13/73; H01R 11/01; H01R 13/512; H01R 13/5202; H01R 13/6315; H01R 13/6581; H01R 13/701; H01R 13/713

(57) ABSTRACT

A connecting apparatus for a busway includes a first busbar plug, a second busbar connector, and a flexible connector. The first busbar plug is coupled to a first busbar. The second busbar connector includes a connecting body and an adjusting assembly. The connecting body is coupled to a second busbar. The adjusting assembly is coupled to the connecting body and the first busbar plug, and adapted to adjust a position of the connecting body relative to the first busbar plug in a first direction and a second direction different from the first direction, so as to facilitate a connection between the first busbar and the second busbar. The flexible connector is flexibly connected between the first busbar plug and the connecting body to allow the connecting body to move relative to the first busbar plug while establishing an electrical connection between the first busbar and the second busbar.

### CROSS-REFERENCE

This application claims priority to Chinese Patent Application No. 202423078614. X, filed on Dec. 12, 2024, and entitled “CONNECTING APPARATUS FOR BUSWAY”, the entirety of which is incorporated herein by reference.

### FIELD

Example embodiments of the present disclosure generally relate to the field of power distribution device, and in particular to a connecting apparatus for a busway.

### BACKGROUND

In a power distribution device (for example, a power distribution device of a data center), a busway serves as a main way of power transmission, and bears a task of transmitting power from a power supply device to each electric load. Existing power distribution busbar system includes a high-current busbar (hereinafter also referred to as a main busbar) and a low-current busbar (hereinafter also referred to as an auxiliary busbar), where the main busbar is used for obtaining power from the power supply, and then the power is transmitted to a terminal box on the auxiliary busbar through a power distribution unit on the main busbar. However, such power distribution device has the problems of high cost, complex installation, difficult maintenance and the like.

### SUMMARY

In a first aspect of the present disclosure, a connecting apparatus for a busway is provided. The connecting apparatus includes a first busbar plug, a second busbar connector, and a flexible connector. The first busbar plug is coupled to a first busbar, the second busbar connector includes a connecting body and an adjusting assembly. The connecting body is coupled to a second busbar. The adjusting assembly is coupled to the connecting body and the first busbar plug, and adapted to adjust a position of the connecting body relative to the first busbar plug in a first direction and a second direction different from the first direction, so as to facilitate a connection between the first busbar and the second busbar. The flexible connector is flexibly connected between the first busbar plug and the connecting body to allow the connecting body to move relative to the first busbar plug while establishing an electrical connection between the first busbar and the second busbar.

In some embodiments, the adjusting assembly includes: a first adjusting plate coupled to the first busbar plug, and arranged to be movable relative to the first busbar plug in the first direction so as to adjust the position of the connecting body in the first direction; and a second adjusting plate coupled to the first adjusting plate, and arranged to be movable relative to the first busbar plug in the second direction, where the connecting body is coupled to the second adjusting plate so as to adjust the position of the connecting body in the second direction.

In some embodiments, the first busbar plug includes: a cabinet body including an opening part; a cover plate coupled to the opening part so as to cover the opening part together with the first adjusting plate.

In some embodiments, the first adjusting plate includes horizontal elongated holes, and the connecting apparatus further includes: a plurality of first connecting rods adapted to respectively pass through the horizontal elongated holes and be coupled to the opening part of the first busbar plug, so as to couple the first adjusting plate to the first busbar plug and allow the connecting body and the second adjusting plate to move along the first direction.

In some embodiments, the second adjusting plate includes vertical elongated holes, and the connecting apparatus further includes a plurality of second connecting rods adapted to respectively pass through the vertical elongated holes and be coupled to the first adjusting plate, so as to couple the second adjusting plate to the first adjusting plate and allow the connecting body to move along the second direction.

In some embodiments, the connecting body includes: a fixing member coupled to the second adjusting plate and adapted to fix a position of the connecting body relative to the second adjusting plate.

In some embodiments, the connecting apparatus further includes: a switching apparatus arranged in the cabinet body and coupled between the first busbar and the flexible connector, and adapted to establish a controllable electrical connection between the first busbar and the second busbar.

In some embodiments, the connecting apparatus further includes: a first seal coupled to the opening part of the cabinet body, and adapted to seal the cover plate and the first adjusting plate.

In some embodiments, the cover plate includes a shielding part extending towards a side of the first adjusting plate, so that when the first adjusting plate moves along the first direction, the cover plate and the first adjusting plate are adapted to be hermetically coupled to the opening part of the cabinet body.

In some embodiments, the connecting apparatus further includes: a second seal coupled to the shielding part of the cover plate adjacent to the first adjusting plate, and adapted to seal the shielding part and the first adjusting plate.

It should be understood that the content described in this content section is not intended to limit the key features or important features of embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 shows a schematic structural diagram of a connecting apparatus connected to a main busbar and an auxiliary busbar according to some embodiments of the present disclosure;

FIG. 2 shows a schematic structural diagram of a connecting apparatus connected to a main busbar according to some embodiments of the present disclosure;

FIG. 3 shows a schematic structural diagram of a connecting apparatus according to some embodiments of the present disclosure;

FIG. 4 shows an exploded view of a connecting apparatus according to some embodiments of the present disclosure; and

FIGS. 5-6 show exploded views of an adjusting assembly according to some embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

In the description of embodiments of the present disclosure, the terms “including” and the like should be understood to include “including but not limited to”. The term “based on” should be understood as “based at least in part on”. The terms “an embodiment” or “the embodiment” should be understood as “at least one embodiment”. The term “some embodiments” should be understood as “at least some embodiments”. Other explicit and implicit definitions may also be included below. The terms “first”, “second”, and the like may refer to different or identical objects. Other explicit and implicit definitions may also be included below.

As briefly mentioned above, existing power distribution device has problems. Specifically, since both the power distribution unit of the main busbar and the terminal box of the auxiliary busbar need to be equipped with a circuit breaker to ensure circuit safety, the terminal box of the auxiliary busbar needs to be installed with the same circuit breaker as that used in the power distribution unit of the main busbar. Such a configuration not only increases the cost of the power distribution device, but also increases the complexity of the power distribution device, especially installing the circuit breaker on the terminal box of the auxiliary busbar will significantly increase the cost.

Secondly, in the existing power distribution device, the power distribution unit of the main busbar is connected to the terminal box of the auxiliary busbar through a cable. Such a connection mode has many inconveniences during the actual installation process. The selection of a length, a routing, and connection points of the cable all requires precise calculation and design, which often requires a large amount of manpower and time to complete installation work. On-site cable installation not only takes a long working time, but also, due to the need to consider issues such as space constraints and electromagnetic interference in the cable layout, the labor cost and the installation difficulty are further increased.

In addition, the maintenance and troubleshooting of the power distribution device becomes more difficult due to the complexity of cable connections. When an electrical fault occurs, the fault location and problem resolution require more time, further increasing the operational cost.

In order to solve or at least partially solve the above problems or other potential problems of the power distribution device in the prior art, embodiments of the present disclosure provide a solution of a connecting apparatus for a busway. A first busbar plug of the connecting apparatus is coupled to the first busbar. Further, a second busbar connector of the connecting apparatus includes a connecting body and an adjusting assembly. The connecting body is coupled to the second busbar. The adjusting assembly is coupled to the connecting body and the first busbar plug, and adapted to adjust a position of the connecting body relative to the first busbar plug in a first direction and a second direction different from the first direction, so as to facilitate a connection between the first busbar and the second busbar. Further, a flexible connector of the connecting apparatus is flexibly connected between the first busbar plug and the connecting body, so as to allow the connecting body to move relative to the first busbar plug while establishing an electrical connection between the first busbar and the second busbar.

In this way, the connection between the first busbar and the second busbar becomes more convenient and efficient through the first busbar plug and the second busbar connector. The adjusting assembly can adjust the position of the connecting body relative to the first busbar plug in two different directions, so that during the actual installation process, butt-joint errors either in the horizontal direction or the vertical direction can be effectively compensated for, the butt-joint process of the busway is effectively simplified, and the installation time and the labor cost are reduced.

Secondly, a reliable electrical connection can be established between the first busbar plug and the connecting body of the second busbar connector through the flexible connector. The flexible connector can not only accommodate the adjustment of the position of the connecting body relative to the first busbar plug by the adjusting assembly in two different directions, but also effectively distribute the high current of the first busbar to the second busbar, ensuring stable current transmission and improving the reliability and safety of the power distribution device.

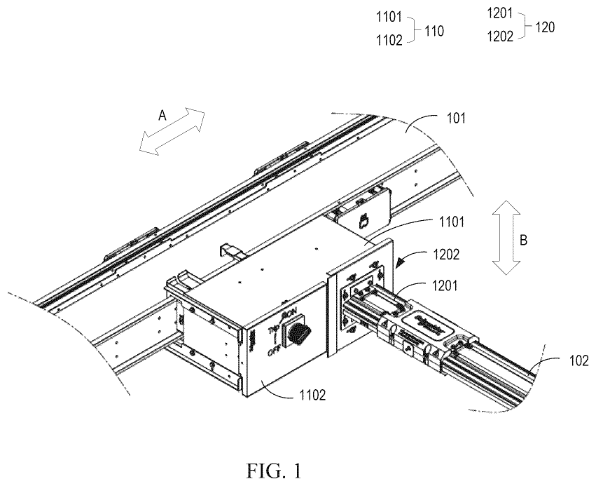

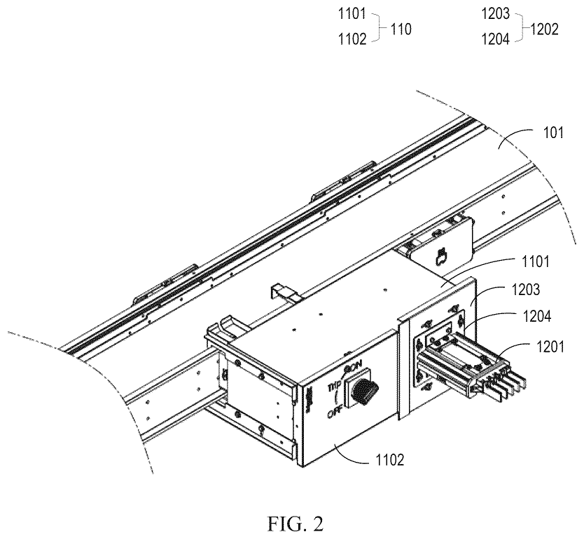

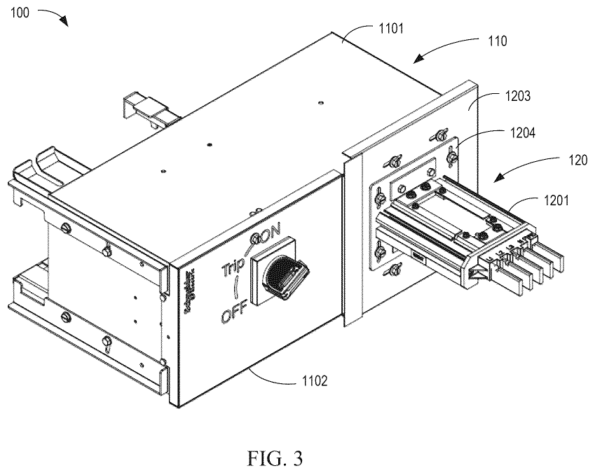

The specific structure and working process of a connecting apparatus 100 for a busway in a power distribution device will be described below with reference to FIGS. 1 to 6. In embodiments of the present disclosure, the connecting apparatus 100 generally includes a first busbar plug 110, a second busbar connector 120, and a flexible connector 130. The second busbar connector 120 is adjustable in position relative to the first busbar plug 110, and the flexible connector 130 is coupled between the first busbar plug 110 and the second busbar connector 120 to accommodate the displacement of the second busbar connector 120. Through the coordinated operation of the first busbar plug 110, the second busbar connector 120, and the flexible connector 130, rapid and precise connection of the busway can be achieved. Meanwhile, a flexible adjustment function is provided, stability and reliability of current transmission are ensured, and tedious cable connection and related labor cost in a traditional installation method are reduced.

Specifically, the first busbar plug 110 is configured to be coupled to the first busbar 101 (for example, a main busbar). In some embodiments, the first busbar plug 110 is fixedly connected to a connecting part of the first busbar 101 through a claw, and a shape and size of the first busbar plug 110 are designed according to different types of main busbars to ensure the firmness and stability of the plug-in connection. The first busbar plug 110 further includes a fixing mechanism (such as a bolt or a clamping structure) for firmly fixing the first busbar plug 110 on the first busbar 101 to prevent loosening during use, so as to ensure reliability of the electrical connection.

Further, the second busbar connector 120 includes a connecting body 1201 and an adjusting assembly 1202. Specifically, the connecting body 1201 is configured to be coupled to the second busbar 102 (for example, an auxiliary busbar). For example, the connecting body 1201 is connected to the auxiliary busbar 102 through an auxiliary busbar connector. Meanwhile, the connecting body 1201 is connected to the adjusting assembly 1202, and the position of the connecting body 1201 in a first direction A and a second direction B can be adjusted through the adjusting assembly 1202.

Further, the adjusting assembly 1202 is connected to the first busbar plug 110, and configured to adjust the position of the connecting body 1201 in two directions. In some embodiments, the adjusting assembly 1202 includes a horizontal adjustment screw and a vertical adjustment screw, and the position of the second busbar connector 120 relative to the first busbar plug 110 can be precisely adjusted by adjusting these screws. Adjustment direction includes the first direction A (for example, a horizontal direction) and the second direction B (for example, a vertical direction) different from the first direction A, so as to ensure that the first busbar 101 and the second busbar 102 can be precisely butt-jointed, and no gap or misalignment occurs during the connection process.

Further, the flexible connector 130 is configured to be connected with the first busbar 101 and the second busbar 102, and can adapt to relative positional changes between the first busbar plug 110 and the second busbar connector 120. That is, the flexible connector 130 is connected between the first busbar plug 110 and the connecting body 1201 of the second busbar connector 120. The flexible connector 130 can be made of a material with high temperature resistance and good conductivity (such as copper or aluminum alloy), and has certain flexibility and elasticity, so that the flexible connector 130 can adapt to deviations or changes of the busway during the installation process. The flexible connector 130 can effectively distribute the current of the main busbar to the auxiliary busbar to ensure the uniformity and stability of power transmission.

During actual installation process, the first busbar plug 110 is first connected and fixed to the first busbar 101 through the claw. Next, the flexible connector 130 (e.g., a cable, a soft connection, a copper bar, etc.) is installed between the first busbar plug 110 and the second busbar connector 120 to achieve current conduction. Meanwhile, the position of the second busbar connector 120 is adjusted through the adjusting assembly 1202, so that the connecting body 1201 is butt-jointed and aligned with the second busbar. Through adjustment in the horizontal and vertical directions, precise butt-joint between the two is ensured. Throughout the installation process, no complex cable connection is required, and an installer only needs to perform simple adjustments and fixations on the second busbar connector 120, thereby reducing installation time and labor cost.

In addition, the connecting apparatus 100 is suitable for connection of various main busbars and auxiliary busbars. By replacing the mating parts of the first busbar plug 110 and the second busbar connector 120, interconnection between busbars of different models can be achieved. Therefore, it can not only be applied to existing busbar systems, but also can adapt to changes in future busway designs, ensuring long-term practicability and stability.

In embodiments according to the present disclosure, by adjusting horizontal and vertical positions of the second busbar connector, the connecting apparatus can be accurately positioned in different installation environments, ensuring the stability and accuracy of the connection between the first busbar and the second busbar. Other benefits will be described in detail below in connection with corresponding embodiments.

In some embodiments, the adjusting assembly 1202 of the second busbar connector 120 includes a first adjusting plate 1203 and a second adjusting plate 1204. Specifically, the first adjusting plate 1203 is coupled to the first busbar plug 110 and is arranged to be movable relative to the first busbar plug 110 in the first direction A (e.g., a horizontal direction). By adjusting the relative position of the first adjusting plate 1203, the positions of the connecting body 1201 and the second adjusting plate 1204 in the first direction A are adjusted. The first adjusting plate 1203 can be connected to the first busbar plug 110 by a slide rail, a guide rail or other mechanical structures to ensure smoothness and stability during its moving process. During adjustment, the first adjusting plate 1203 can be moved in the first direction A by rotating an adjusting bolt or other adjusting apparatus, so that the connecting body 1201 can be precisely adjusted in the horizontal direction to ensure the butt-joint accuracy of the busbar connection.

Further, the second adjusting plate 1204 is coupled to the first adjusting plate 1203 and is arranged to be movable relative to the first busbar plug 110 in the second direction B (e.g., a vertical direction). By adjusting the position of the second adjusting plate 1204, the position of the connecting body 1201 in the second direction B is further precisely adjusted, so as to achieve accurate butt-joint between the first busbar 101 and the second busbar 102. A connection structure between the second adjusting plate 1204 and the first adjusting plate 1203 may adopt a sliding connection manner to ensure smooth movement of the second adjusting plate 1204 in the vertical direction. During the adjustment process, it is also possible to ensure that the second adjusting plate 1204 moves precisely in the vertical direction by means of a thread adjusting apparatus or other adjusting mechanism, thereby achieving butt-joint.

The adjustment process of the connecting body 1201 is further described. The connecting body 1201 is coupled to the second adjusting plate 1204 and is adjusted in the second direction B as the second adjusting plate 1204 moves. Under the combined action of the first adjusting plate 1203 and the second adjusting plate 1204, both the horizontal and vertical positions of the connecting body 1201 can be adjusted to ensure that the butt-joint angle and the positional relationship between the first busbar and the second busbar meet the installation requirements. The adjusting process is achieved by manual operation of a bolt or other adjusting apparatus, and during the adjustment process, the adjustment of the butt-joint position can be quickly and conveniently completed according to specific on-site conditions.

In this way, through the dual adjustment of the first adjusting plate 1203 and the second adjusting plate 1204, precise positioning of the connecting body 1201 in the two directions can be achieved, and the butt-joint between the connecting body 1201 and the auxiliary busbar 102 can be ensured. The high efficiency and safety during the connection process are ensured, and meanwhile the installation complexity and time cost associated with the traditional cable connection method are reduced.

In some embodiments, the first busbar plug 110 includes a cabinet body 1101 and a cover plate 1102. Specifically, the cabinet body 1101 provides support and accommodation space for busbar plug-in connection. The cabinet body 1101 has an opening part for coupling the first adjusting plate 1203 to its internal structure. A size and shape of the opening part is designed according to a size of a desired connector to ensure that the first adjusting plate 1203 can move and achieve the desired adjustment. The cabinet body 1101 is made of a robust material, such as a metal or high-strength alloy, to ensure that it has sufficient mechanical strength and durability to withstand the current load and mechanical pressure during the busbar plug-in connection process.

Further, the cover plate 1102 is coupled to the opening part of the cabinet body 1101 for closing the opening part and co-covering this region with the first adjusting plate 1203. The cover plate 1102 can not only close the cabinet body 1101, protect internal elements from external environmental influences, but also ensure the stability of the adjusting assembly during the adjustment process. The cover plate 1102 may adopt a detachable structure, which facilitates maintenance and inspection. A connection between the cover plate 1102 and the opening part may be achieved by a screw, a snap-fit, or other fixing mechanisms, ensuring a tight fit between the cover plate 1102 and the cabinet body 1101, thereby improving structural stability and safety of the connecting apparatus 100.

In some embodiments, the cabinet body 1101 includes a plurality of opening parts, and the cover plate 1102 and the first adjusting plate 1203 respectively cover the opening parts on different surfaces of the cabinet body 1101. That is, the cover plate 1102 and the first adjusting plate 1203 may be respectively disposed on different surfaces of the cabinet body 1101, which is not specifically limited in embodiments of the present disclosure.

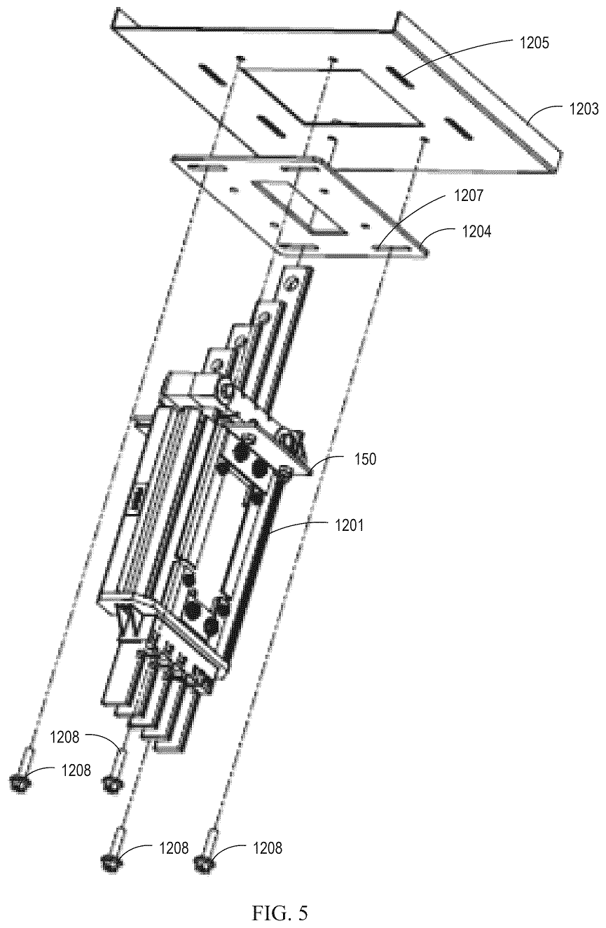

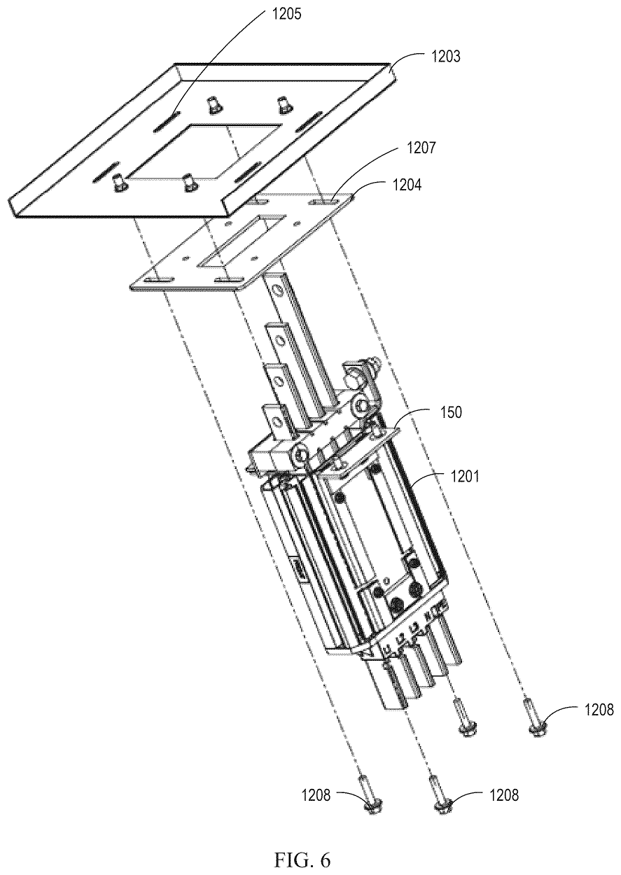

As shown in FIGS. 5 and 6, in some embodiments, the first adjusting plate 1203 includes horizontal elongated holes 1205, and the connecting apparatus 100 further includes a plurality of first connecting rods. Specifically, the first adjusting plate 1203 is provided with a plurality of horizontal elongated holes 1205, and the horizontal elongated holes 1205 are used to allow the first adjusting plate 1203 to move relative to the first busbar plug 110 in the horizontal direction (that is, the first direction A). Lengths and the positions of the horizontal elongated holes 1205 are designed according to the range and precision required for adjustment, so as to ensure that the first adjusting plate 1203 can perform appropriate translation during the installation process.

Further, the plurality of first connecting rods are used to couple the first adjusting plate 1203 to the opening part of the first busbar plug 110. Each first connecting rod passes through the horizontal elongated hole 1205 on the first adjusting plate 1203 and is connected to the opening part of the first busbar plug 110. Two ends of the first connecting rod may be provided with threads or snap-fit structures, so as to fix the first connecting rod to the opening part of the first busbar plug 110 by bolts, nuts or other fasteners. The number and size of the first connecting rods are adjusted according to requirements of specific applications, so as to ensure that the first adjusting plate 1203 remains stable during the adjustment process, and can support the movement of the connecting body 1201 and the second adjusting plate 1204. For example, the plurality of first connecting rods may be four in number and arranged at four corners of the first adjusting plate 1203, respectively.

Through the coupling of the plurality of first connecting rods, a stable connection structure is formed between the first adjusting plate 1203 and the first busbar plug 110. The movement of the horizontal elongated holes 1205 of the first adjusting plate 1203 relative to the first connecting rods enables the connecting body 1201 and the second adjusting plate 1204 to be adjusted along the first direction A. Specifically, by loosening or tightening the first connecting rods with adjusting bolts or other adjusting tools, fine adjustment of the position of the first adjusting plate 1203 is achieved, the flexibility and adjustability of the busway connecting apparatus during installation are ensured, and the positions of the main busbar and the auxiliary busbar can be adjusted as needed.

In some embodiments, the second adjusting plate 1204 is coupled to the first adjusting plate 1203 through a plurality of second connecting rods 1208. Specifically, the second adjusting plate 1204 includes vertical elongated holes 1207. The vertical elongated holes 1207 are used to allow the second adjusting plate to move relative to the first adjusting plate 1203 in the vertical direction (i.e., the second direction B). Lengths and widths of the vertical elongated holes 1207 can be designed according to required adjustment range and precision, so as to ensure that the second adjusting plate 1204 can slide during adjustment while a stable connection with the first adjusting plate 1203 is ensured.

Further, the plurality of second connecting rods 1208 pass through the vertical elongated holes 1207 and are coupled to the first adjusting plate 1203. Two ends of each second connecting rod 1208 may be connected to the first adjusting plate 1203 and the second adjusting plate 1204 by threads, snap-fits or other fixing apparatuses. The number and the length of the second connecting rod 1208 are designed according to actual adjustment requirements, ensuring that the second adjusting plate 1204 and the first adjusting plate 1203 can maintain a stable connection during the adjustment process. The second connecting rods 1208 are used to couple the second adjusting plate 1204 to the first adjusting plate 1203, and during the adjustment process, the second adjusting plate 1204 is allowed to move along the second direction B to ensure that the connecting body 1201 can be adjusted as needed in the vertical direction.

In some embodiments, the connecting body 1201 includes a fixing member 150. The fixing member 150 is connected to the second adjusting plate 1204. The fixing member 150 may be made of a metal material, and may be L-shaped, with two mutually perpendicular components connected to the connecting body 1201 and the second adjusting plate 1204, respectively. The fixing member 150 is used to ensure the stability of the connecting body 1201 and prevent offset or displacement of the connecting body 1201 during the adjustment process. The fixing member 150 may be fixed on the second adjusting plate 1204 by screws or other fixing methods, ensuring that their positions do not change, thereby improving the installation accuracy and reliability of the connecting body 1201.

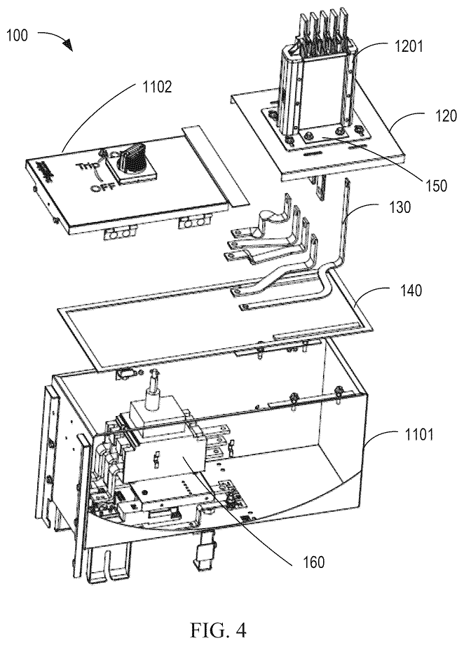

With continued reference to FIG. 4, in some embodiments, the connecting apparatus 100 further includes a switching apparatus 160. The switching apparatus 160 is arranged in the cabinet body 1101 and is coupled between the first busbar 101 and the flexible connector 130. That is, the flexible connector 130 is electrically connected between the switching apparatus 160 and the connecting body 1201. The switching apparatus 160 is configured to control an electrical connection between the first busbar 101 and the second busbar 102. Specifically, the switching apparatus 160 enables a controllable electrical connection or disconnection between the first busbar 101 and the second busbar 102 to be achieved by electrical control or mechanical methods. An installation position of the switching apparatus 160 may be close to a center position of the cabinet body 1101 to facilitate operation and debugging during the installation process. The switching apparatus 160 may take a variety of forms, such as a manual switch, an electric switch, or an automatic switch, and an appropriate type can be selected according to actual needs. Through the switching apparatus 160, the electrical connection between the busbars can be flexibly controlled according to the requirements of power or troubleshooting, and the safety and reliability of the power distribution device are ensured. For example, the switching apparatus 160 may use a circuit breaker, and a manual switch of the circuit breaker may be disposed on the cover plate 1102.

In this way, by eliminating the circuit breaker of the terminal box on the auxiliary busbar and integrating the related metering and protection functions into the power distribution unit of the main busbar, the structure and installation process of the power distribution device are further simplified. Eliminating cable connection not only reduces device cost, but also reduces the complexity of on-site installation and possible cable connection failure, significantly improving the maintenance efficiency and reliability of the power distribution device.

In some embodiments, the cover plate 1102 includes a shielding part extending towards a side of the first adjusting plate 1203. Specifically, the cover plate 1102 is provided with a shielding part, and the shielding part extends towards the side of the first adjusting plate 1203. The shielding part is used to ensure that the cover plate 1102 and the first adjusting plate 1203 can tightly seal the opening part of the cabinet body 1101 when the first adjusting plate 1203 moves along the first direction A (that is, the horizontal direction). A length, width and shape of the shielding part are designed according to the actual contact region of the cover plate 1102 and the first adjusting plate 1203, as well as the required sealing effect. An extending part of the shielding part forms good contact with an edge of the first adjusting plate 1203, and maintains sealing performance during the adjustment process, thereby preventing external dust, moisture and the like from entering the interior of the cabinet body 1101.

An effective sealing surface can be formed between the cover plate 1102 and the first adjusting plate 1203 through the shielding part extending towards the side of the first adjusting plate 1203. Even if the first adjusting plate 1203 is adjusted along the first direction A during the installation process or during operation, the shielding part can ensure that the contact between the cover plate 1102 and the first adjusting plate 1203 does not loosen, thereby maintaining the sealing performance. An extension length and shape of the shielding part may be determined according to the adjustable range of the first adjusting plate 1203.

The cover plate 1102 is coupled to the first adjusting plate 1203 through the shielding part, and is hermetically fitted with the opening part of the cabinet body 1101. A connection method between the cover plate 1102 and the cabinet body 1101 may be a fixing manner such as a snap-fit, a screw or a spring snap-fit, to ensure that the cover plate 1102 is firmly fixed to the opening part of the cabinet body 1101.

In some embodiments, the connecting apparatus 100 further includes a first seal 140 and a second seal. Specifically, the first seal 140 is coupled to the opening part of the cabinet body 1101 for sealing a contact region between the cover plate 1102 and the first adjusting plate 1203. The first seal 140 may be made of rubber, silica gel or other flexible material with high sealing performance, and has good elasticity and durability. The first seal 140 can ensure the sealing performance between the cover plate 1102 and the first adjusting plate 1203, preventing dust, moisture, or other external substances from entering the interior of the cabinet body 1101, thereby protecting the internal electrical components from the external environmental influences. A size and shape of the first seal 140 are designed according to a size of the opening part of the cabinet body 1101, ensuring that the contact surface of the cover plate 1102 and the first adjusting plate 1203 can be completely covered, and providing good sealing performance.

Further, the second seal is coupled to the shielding part of the cover plate 1102 and is adapted to seal a contact region between the shielding part and the first adjusting plate 1203. The second seal may be located at an edge of the cover plate 1102 or a part of the cover plate 1102 adjacent to the first adjusting plate 1203. Through the installation of the second seal, dust, moisture, or other contaminants may be effectively prevented from entering the interior of the cabinet body 1101 from these seams. The second seal can be made of the same material as the first seal 140, such as a rubber or silicone material with high elasticity and strong weather resistance, which can adapt to temperature change and physical pressure during long-term operation of the cabinet body 1101. The sealing performance of the power distribution device can be improved through the second seal. An installation method of the seal can adopt connection methods such as snap-fit, adhesion, or embedding to ensure that it is not easy to fall off or be damaged during use.

In this way, the overall protection performance of the power distribution device is improved through the first seal 140 and the second seal, the device can operate stably for a long time in various harsh environments, and meanwhile, the maintenance frequency is reduced and the service life of the power distribution device is prolonged.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A connecting apparatus for a busway, comprising:
a first busbar plug coupled to a first busbar;
a first busbar connector comprising:
a connecting body coupled to a second busbar; and
an adjusting assembly coupled to the connecting body and the first busbar plug, and adapted to adjust a position of the connecting body relative to the first busbar plug in a first direction and a second direction different from the first direction, so as to facilitate a connection between the first busbar and the second busbar; and
a flexible connector flexibly connected between the first busbar plug and the connecting body to allow the connecting body to move relative to the first busbar plug while establishing an electrical connection between the first busbar and the second busbar.

2. The connecting apparatus of claim 1, wherein the adjusting assembly comprises:
a first adjusting plate coupled to the first busbar plug, and arranged to be movable relative to the first busbar plug in the first direction so as to adjust the position of the connecting body in the first direction; and
a second adjusting plate coupled to the first adjusting plate, and arranged to be movable relative to the first busbar plug in the second direction, wherein the connecting body is coupled to the second adjusting plate so as to adjust the position of the connecting body in the second direction.

3. The connecting apparatus of claim 2, wherein the first busbar plug comprises:
a cabinet body comprising an opening part; and
a cover plate coupled to the opening part so as to cover the opening part together with the first adjusting plate.

4. The connecting apparatus of claim 3, wherein
the first adjusting plate comprises horizontal elongated holes, and
the connecting apparatus further comprises:
a plurality of first connecting rods adapted to respectively pass through the horizontal elongated holes and be coupled to the opening part of the first busbar plug, so as to couple the first adjusting plate to the first busbar plug and allow the connecting body and the second adjusting plate to move along the first direction.

5. The connecting apparatus of claim 3, wherein
the second adjusting plate comprises vertical elongated holes, and
the connecting apparatus further comprises:
a plurality of second connecting rods adapted to respectively pass through the vertical elongated holes and be coupled to the first adjusting plate, so as to couple the second adjusting plate to the first adjusting plate and allow the connecting body to move along the second direction.

6. The connecting apparatus of claim 3, wherein the connecting apparatus further comprises:
a switching apparatus arranged in the cabinet body and coupled between the first busbar and the flexible connector, and adapted to establish a controllable electrical connection between the first busbar and the second busbar.

7. The connecting apparatus of claim 3, wherein the connecting apparatus further comprises:
a first seal coupled to the opening part of the cabinet body, and adapted to seal the cover plate and the first adjusting plate.

8. The connecting apparatus of claim 3, wherein the cover plate comprises a shielding part extending towards a side of the first adjusting plate, so that when the first adjusting plate moves along the first direction, the cover plate and the first adjusting plate are adapted to be hermetically coupled to the opening part of the cabinet body.

9. The connecting apparatus of claim 3, wherein the connecting body comprises:
a fixing member coupled to the second adjusting plate and adapted to fix a position of the connecting body relative to the second adjusting plate.

10. The connecting apparatus of claim 9, wherein the fixing member is made of a metal material, and is L-shaped, with two mutually perpendicular components connected to the connecting body and the second adjusting plate, respectively.

11. The connecting apparatus of claim 10, wherein the connecting apparatus further comprises:
a second seal coupled to a shielding part of the cover plate adjacent to the first adjusting plate, and adapted to seal the shielding part and the first adjusting plate.

12. The connecting apparatus of claim 11, wherein the second seal is located at an edge of the cover plate or a part of the cover plate adjacent to the first adjusting plate.

13. The connecting apparatus of claim 1, wherein the first busbar plug is fixedly connected to a connecting part of the first busbar through a claw.

14. A connecting apparatus comprising:
a busbar plug coupled to a first busbar;
a first busbar connector comprising:
a connecting body coupled to a second busbar; and
an adjusting assembly coupled to the connecting body and the first busbar plug, and adapted to adjust a position of the connecting body relative to the busbar plug in a first direction and a second direction different from the first direction, so as to facilitate a connection between the first busbar and the second busbar; and
a flexible connector flexibly connected between the busbar plug and the connecting body to allow the connecting body to move relative to the busbar plug while establishing an electrical connection between the first busbar and the second busbar.

15. The connecting apparatus of claim 14, wherein the adjusting assembly comprises:
a first adjusting plate coupled to the first busbar plug, and arranged to be movable relative to the first busbar plug in the first direction so as to adjust the position of the connecting body in the first direction; and
a second adjusting plate coupled to the first adjusting plate, and arranged to be movable relative to the first busbar plug in the second direction, wherein the connecting body is coupled to the second adjusting plate so as to adjust the position of the connecting body in the second direction.

16. The connecting apparatus of claim 15, wherein the first busbar plug comprises:
a cabinet body comprising an opening part; and
a cover plate coupled to the opening part so as to cover the opening part together with the first adjusting plate.

17. The connecting apparatus of claim 16, wherein
the first adjusting plate comprises horizontal elongated holes, and
the connecting apparatus further comprises:
a plurality of first connecting rods adapted to respectively pass through the horizontal elongated holes and be coupled to the opening part of the first busbar plug, so as to couple the first adjusting plate to the first busbar plug and allow the connecting body and the second adjusting plate to move along the first direction.

18. The connecting apparatus of claim 16, wherein
the second adjusting plate comprises vertical elongated holes, and
the connecting apparatus further comprises:
a plurality of second connecting rods adapted to respectively pass through the vertical elongated holes and be coupled to the first adjusting plate, so as to couple the second adjusting plate to the first adjusting plate and allow the connecting body to move along the second direction.

19. The connecting apparatus of claim 15, wherein the connecting body comprises:
a fixing member coupled to the second adjusting plate and adapted to fix a position of the connecting body relative to the second adjusting plate.

20. A system comprising:
a first busbar;
a second busbar; and
a connecting apparatus comprising:
a busbar plug coupled to the first busbar;
a first busbar connector comprising:
a connecting body coupled to the second busbar; and
an adjusting assembly coupled to the connecting body and the first busbar plug, and adapted to adjust a position of the connecting body relative to the busbar plug in a first direction and a second direction different from the first direction, so as to facilitate a connection between the first busbar and the second busbar; and
a flexible connector flexibly connected between the busbar plug and the connecting body to allow the connecting body to move relative to the busbar plug while establishing an electrical connection between the first busbar and the second busbar.
